(19) United States
(12) Patent Application Publication
(10) Pub. No.: US 2026/0213528 A1
(43) Pub. Date: Jul. 23, 2026

(54) A SURGE PROTECTION CIRCUIT

(71) Applicant: SIGNIFY HOLDING B.V., EINDHOVEN (NL)

(72) Inventor: LIJUN ZHOU, SHANGHAI (CN)

(21) Appl. No.: 19/144,609

(22) PCT Filed: Dec. 7, 2023
(86) PCT No.: PCT/EP2023/084732

§ 371 Date: Jun. 30, 2025

(30) Foreign Application Priority Data
Jan. 3, 2023 (WO) PCT/CN2023/070092
Feb. 20, 2023 (EP) 23157472.4

(51) Int. Cl. H02H 9/04; H05B 45/50

(52) U.S. Cl. CPC H02H 9/04; H05B 45/50

(57) ABSTRACT

A surge protection circuit for a DC power supply. A voltage clamping circuit is connected between a power terminal and a protective earth terminal. The voltage clamping circuit is configured to reduce its impedance when a voltage across it exceeds a threshold voltage. An active switch is configured to, when the voltage across the protective earth terminal reduces again, control an electrical parameter for the voltage clamping circuit such that such that the voltage clamping circuit's impedance recovers to high. In one embodiment, the active switch is connected between a positive power terminal and a negative power terminal. In another embodiment, there is another recoverable component in series with the voltage clamping circuit and having a smaller voltage rating than that of the voltage clamping circuit and the active switch is connected in parallel with the recoverable component.

### FIELD OF THE INVENTION

The present invention relates to the field of surge protection.

### BACKGROUND OF THE INVENTION

There are a wide variety of drivers for use in driving or powering an electric device, such as a lighting device. It is common to provide surge protection circuits for use with such drivers, in order to protect the electric device from surge voltages.

Some existing surge protection circuits, designed for AC power supplies, comprise a voltage clamping circuit between an AC power terminal and a protective earth.

When a voltage surge occurs, a voltage across the voltage clamping circuit exceeds a breakdown voltage. This causes the voltage clamping circuit to become conductive and clamp the voltage at the power terminal to a clamping voltage. After the surge, the voltage across the voltage clamping circuit needs to drop below a recovery threshold voltage in order to reset the voltage clamping circuit for future use. For AC power supplies, this is achieved by a natural zero crossing of the AC power provided to the power terminal.

As technology develops, surge protection on the DC side is also preferred. FIG. 5 shows a known circuit using the voltage clamping circuit with DC power supply. The normal output voltage of the DC power supply is just 28V, sufficiently low to reset the voltage clamping circuit. However, such surge protection circuits cannot be used with a DC power supply whose output voltage in normal operation is typically greater than the recovery threshold voltage. For example, in LED drivers, the output voltage provided by a DC supply, e.g., between V+ and V−, can be several hundreds of Volts and the corresponding voltage between the V+ and the protective earth (GND) is also very high, and therefore not able to reset the voltage clamping circuit.

The voltage clamping circuit can therefore not be used to protect against surge voltages unless it is reset. Thus there is an ongoing desire to improve the operation and/or performance of surge protection circuits, and in particular, to provide a surge protection circuit that can be used for a DC power supply. More specifically, a technology that is able to reset the voltage clamping circuit used for a high voltage DC power supply is needed, wherein the DC power supply's rated voltage is too high to reset the voltage clamping circuit on its own.

U.S. Pat. No. 5,436,786A1, GB2542789A, and JP2015211602A disclose a parallel bypassing component to bypass a concerned surge protection component so as to recover the surge protection component back to the turn off state.

### SUMMARY OF THE INVENTION

The invention is defined by the claims.

The proposed invention overcomes the abovementioned problems by using an additional active switch to reset the voltage clamping circuit when a surge voltage has ended, i.e., when a voltage across the voltage clamping circuit drops below the breakdown voltage. The active switch can, for instance, prevent a current from flowing through the voltage clamping circuit when the surge voltage has ended in order to reset the voltage clamping circuit. Alternatively, the active switch can limit a voltage across the voltage clamping circuit when the surge voltage has ended in order to reset the voltage clamping circuit. This provides a technique for performing surge protection using widely available surge protection circuit components and design on high voltage DC side.

The proposed approach thereby overcomes problems with surge protection with DC power supplies which have not previously been addressed.

According to examples in accordance with an aspect of the invention, there is provided a surge protection circuit for use between a DC power supply and a load.

The surge protection circuit comprises: a power terminal configured to connect between the DC power supply and the load, wherein said power terminal is one of a positive power terminal, of the surge protection circuit (200, 300), configured to connect between a positive output of the DC power supply and a positive input of the load, and a negative power terminal, of the surge protection circuit (200, 300), configured to connect between a negative output of the DC power supply and a negative input of the load; a protective earth terminal different from the positive and the negative terminals and configured to connect to a protective earth; and a voltage clamping circuit connected between the power terminal and the protective earth terminal and adapted to: reduce its impedance to a low impedance and clamp the voltage across the voltage clamping circuit, responsive to a voltage across the voltage clamping circuit exceeding a surge threshold voltage; and recover to a high impedance responsive to an electrical parameter across the voltage clamping circuit falling below a recovery threshold.

There are two implementations. First, the surge protective circuit further comprises: a control circuit comprising an active switch connected between the positive power terminal and the negative power terminal and configured to, when operated, limit the electrical parameter across the voltage clamping circuit below the recovery threshold. The control circuit is adapted to operate the active switch to short circuit the DC power supply after the voltage exceeding the surge threshold voltage ends, to thereby cause the voltage clamping circuit to recover to the high impedance.

This approach provides a technique that achieves one or both functions of actively pulling voltage and/or current at the output so as to reset the voltage clamping circuit; and creating a fault at the output of the DC power supply so as to trigger the inherent protection mechanism of the DC power supply to limit its output power so as to reset the voltage clamping circuit.

This embodiment is especially suitable for DC power supplies that have such an inherent protection mechanism. For example, the DC power supplies may have an undervoltage protection or an overcurrent protection. The active circuit can create this undervoltage or overcurrent so as to stop or interrupt the normal operation of DC power supplies.

Second, the surge protective circuit further comprises: a control circuit comprising a recoverable component connected in series with the voltage clamping circuit; and an active switch is connected in parallel with said recoverable component, wherein recoverable component has a smaller voltage rating than that of the voltage clamping circuit and the control circuit is configured to operate the active switch to cause the voltage clamping circuit to recover to the high impedance by closing the active switch to bypass the recoverable component and recover the recoverable component to a high impedance state; and subsequently opening the active switch to thereby cut off current through the voltage clamping circuit.

This provides a technique for reliable and quick forced recovery of the voltage clamping circuit. This embodiment does not rely on the DC power supply to limit its output to reset the voltage clamping circuit, as the previous embodiment, but rather actively cuts off the voltage clamping circuit. Therefore, it does not need the DC power supply to have the inherent protection mechanism, and has broad compatibility with a greater variety of DC power supplies. Preferably, the recoverable component with a small voltage rating is easier to be turned off than the voltage clamping circuit with a high voltage rating.

The present disclosure provides a mechanism for providing surge protection to a load powered by a DC supply.

A voltage clamping circuit is configured to be triggered when a voltage (e.g., a common mode voltage) provided to the load exceeds a surge threshold voltage. When triggered, the impedance of the voltage clamping circuit drops or reduces. The voltage clamping circuit may be designed to recover to its original (higher) impedance when an electrical parameter through or across (e.g., a voltage across or a current through) the voltage clamping circuit falls below a recovery threshold, e.g., the voltage across drops below a second (lower) threshold voltage.

It has been recognized that, for a DC supply, the normal power (sometimes called a rated power) supplied to the load by the DC supply may provide an electrical parameter that exceeds the recovery threshold. This effect is particularly pronounced in high voltage scenarios, e.g., when powering lighting modules. Thus, under normal conditions, the voltage clamping circuit would not be able to recover its original impedance even after the surge voltage has ended.

The proposed approach makes use of an active switch configured to limit the current through or the voltage across the voltage clamping circuit for a period of time after the surge voltage has ended. This can effectively deactivate or reset the voltage clamping circuit. This provides a mechanism for providing surge voltage protection using a voltage clamping circuit with a DC supply.

The voltage exceeding the surge threshold voltage may result from a surge voltage. A surge voltage may come about as a result of an surged AC supply which is converted by the DC supply. Alternatively, the surge voltage may be injected by lightning or another electrostatic discharge occurring between the DC supply and the load, for example, if a lightning bolt strikes at the power wire to the load.

The electrical parameter across the voltage clamping circuit may be either voltage or current. For example, the electrical voltage falls below a recovery threshold when the voltage across the voltage clamping circuit is below a second threshold voltage, lower than the surge threshold voltage. In some alternative examples, the electrical current across the voltage clamping circuit may fall below a recovery threshold when a current through the voltage clamping circuit is below a first threshold current.

Under the teaching of the present application, approaches for appropriately configuring or designing a voltage clamping circuit for this purpose will be apparent to the skilled person. These approaches provide a technique for defining or controlling how to reset or recover the voltage clamping circuit.

The voltage clamping circuit may comprise at least one of: a voltage clamping component configured to clamp a voltage across the voltage clamping component, optionally to a non-zero clamping voltage, responsive to the voltage across the voltage clamping circuit exceeding the surge threshold voltage; and a conduction component configured to become conductive responsive to the voltage across the voltage clamping circuit exceeding the surge threshold voltage. Both of these components can, by themselves, act as the voltage clamping circuit. However, they are particularly advantageous when they are both formed in the voltage clamping circuit to perform fast surge protection (via the conduction component) whilst reducing a risk of sudden changes to the voltage supplied to the load, via the voltage clamping component. The voltage clamping component is usually a varistor and more often a metal-oxide varistor MOV. The conduction component is usually a gas discharge tube GDT. Please note that other components can also be used.

The control circuit may further comprise a detecting component configured to sense a current through the voltage clamping circuit. The control circuit may be configured to operate the active switch responsive to the sensed current. For instance, the control circuit may operate the active switch when the sensed current rises above a second threshold current. This approach provides a simple technique for detecting when the voltage clamping circuit has been activated, such that current flow therethrough, and therefore the time at which the voltage clamping circuit needs to be reset.

The control circuit may be configured to stop operating the active switch responsive to the sensed current falling below the second threshold current. In particularly preferable examples, the control circuit is configured to stop operating the active switch when the sensed current falls to zero. This approach provides a technique for deactivating the active switch when the function of resetting the voltage clamping circuit is no longer needed, i.e., as the voltage across the voltage clamping circuit is likely to already fall below the surge threshold voltage and the surge has ceased.

The control circuit may further comprise a delay circuit configured to delay the sensed current through the voltage clamping circuit; and the control circuit is configured to operate (and optionally stop operating) the active switch responsive to the delayed sensed current. This increases the robustness of the surge protection circuit, and reduces a likelihood that the voltage clamping circuit will be triggered by noise in the circuit.

The control circuit may be configured to operate the active switch responsive to the delayed sensed current rising above a first value; and stop operating the active switch responsive to the delayed sensed current falling below a second value. This approach provides a simple and reliable mechanism for controlling the operation of the active switch. The first and second values may be the same or different.

The detecting component may comprise a first winding connected in series with the voltage clamping circuit; and a second winding magnetically coupled to the first winding so as to produce a current responsive to a current flow through the voltage clamping circuit. The control circuit may be adapted to operate the active switch responsive to the produced current. This approach provides a low-cost but accurate mechanism for sensing a current through the voltage clamping circuit. This technique also electrically isolates the control of the active switch from the voltage clamping circuit, reducing a likelihood of unintentional triggering of the active switch. further, the surge current itself is often too large to control the active circuit safely, thus the windings achieve a down conversion.

The power terminal may be the positive power terminal configured to connect between the positive output of the DC power supply and the positive input of the load. The power terminal may alternatively be the negative terminal.

The surge protection circuit may further comprise a negative power terminal configured to connect between a negative output of the DC power supply and a negative input of the load.

There is also proposed a lighting module comprising: the surge protection circuit herein disclosed; the load, wherein the load comprises an LED lighting load; and a housing for the LED lighting load, wherein the housing is configured to connect to the protective earth. The LED lighting load and the housing may have a parasitic leakage path along which the LED lighting load is breaking down when a voltage, optionally a surge voltage, provided to the LED lighting load with respect to the protective earth exceeds a breakdown voltage. The proposed technique is particularly advantageous when used to provide surge protection to a load that, if a surge voltage occurs, will have a parasitic leakage path that could damage the load or prove dangerous to an individual in the vicinity of the load.

The surge threshold voltage is preferably lower than the breakdown voltage. This causes the surge protection circuit to be adapted to prevent the voltage provided to the LED lighting load reaching the breakdown voltage thus the lighting module would not break down at the parasitic leakage path. This technique advantageously provides a more reliably lighting module, e.g., one that is less susceptible to damage as a result of any surge voltages.

There is also proposed a lighting arrangement comprising: the lighting module herein disclosed; and the DC power supply, with a positive output of the DC power supply connected to the positive input of the load via the positive terminal of the surge protection circuit and a negative output of the DC power supply connected to the negative input of the load via the negative terminal of the surge protection circuit. The DC power supply is configured to be operable in an operation mode, in which operation mode the DC power supply is adapted to generate a rated power at the power terminal which rated power is able produce the electrical parameter across the voltage clamping circuit higher than the recovery threshold.

The DC power supply may operate in the operative mode after the voltage exceeding the surge threshold voltage ends and the active switch has not been operated. Thus the present application provides compatibility between the voltage clamping circuit and the DC power supply at the DC side, and the DC side can also be protected by the already well developed voltage clamping circuit with just the additional simple control circuit proposed by the application. The cost is very low and reliability is high.

In some examples, the DC power supply is configured to provide a first supply voltage at a positive terminal and a second supply voltage at a negative terminal, the first supply voltage being greater than the second supply voltage. The control circuit may be connected between the positive terminal and the negative terminal.

The control circuit may be configured to short circuit the DC power supply, wherein said DC power supply is adapted to, upon the short circuiting, switch from the operation mode to a protection mode and reduce the power on the positive output to a lower power than the rated power, wherein the lower power is adapted to generate the electrical parameter across the voltage clamping circuit lower than the recovery threshold so as to recover the voltage clamping circuit to high impedance.

This approach exploits the protection mode of the DC power supply to improve the surge protection.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an existing surge protection circuit on AC input side;

FIG. 2 illustrates a proposed surge protection circuit according to an embodiment of the present invention;

FIG. 3 illustrates another proposed surge protection circuit according to another embodiment of the present invention;

FIG. 4 illustrates a lighting arrangement that makes use of a proposed surge protection circuit; and

FIG. 5 illustrates an existing surge protection circuit on DC side suitable for low DC voltage.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a surge protection circuit for a DC power supply. A voltage clamping circuit is connected between a power terminal and a protective earth terminal. The voltage clamping circuit is configured to reduce its impedance when a voltage across it exceeds a threshold voltage. An active switch is configured to, when the voltage across the protective earth terminal reduces again, control an electrical parameter for the voltage clamping circuit such that the voltage clamping circuit's impedance recovers to high.

Embodiments are based on the realization that use of a voltage clamping circuit in a DC-based system means that the voltage across the voltage clamping circuit may never sufficiently reduce to allow the impedance of the voltage clamping circuit to recover after a surge voltage by the DC-based system's own. This would mean that the voltage clamping circuit will freewheel, and continue to conduct due to the normal/rated output power of the DC-based system even when the surge voltage ends. Use of the active switch forces the voltage clamping circuit to recover to a higher impedance, thereby reducing or preventing the conduction of the volage clamping circuit after the surge voltage ends, and resetting the voltage clamping circuit for future surge protection.

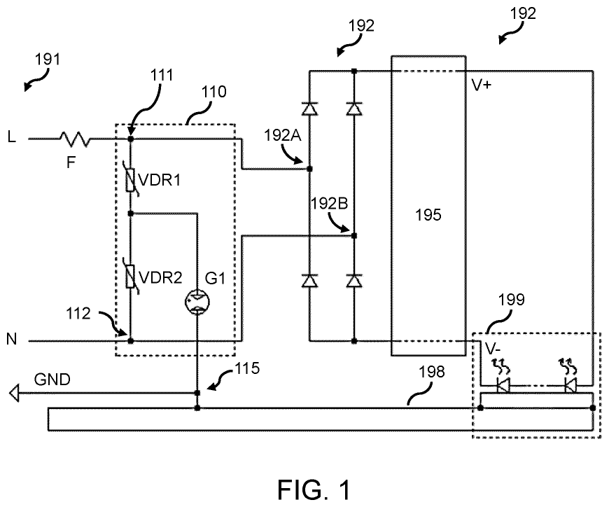

FIG. 1 illustrates an existing surge protection circuit 100 for use between an AC power supply 191 and a load 192. The structure and operating function of this surge protection circuit 100 is hereafter described for the purposes of explanative clarity.

The AC power supply 191 provides a positive output L (live) and a negative output N (neutral). It will be appreciated that, in practice, the AC power supply 191 provides a different output between the positive and negative outputs that cyclically or periodically changes polarity in the form of a sine wave.

The load 192 may, for instance, comprise a rectifying arrangement 192 (here: a bridge rectifier), a driving circuit 195, a heatsink and/or housing 198 and an LED lighting load 199 (comprising one or more LEDs). The load is connected to the positive and negative output of the AC power supply 191 to be powered therefrom.

For a wide variety of loads, it important to keep a maximum voltage provided thereto below a maximum allowable voltage. For instance, if the LED lighting load comprises an insulation dielectric layer, then damage to the insulation dielectric layer (resulting from a high voltage provided to the LED lighting load) or damage to the LED will cause failure. A surge protection circuit 100 is therefore an important element to improve the reliability of the load 192.

The surge protection circuit 100 comprises a first power terminal 111 configured to connect between the AC power supply 191 and the load 192. In the illustrated example, the first power terminal 111 is a positive power terminal that connects between a positive output L of the AC power supply 191 and a positive input 192A of the load 192.

The surge protection circuit 100 also comprises a protective earth terminal 115 configured to connect to a protective earth GND.

The surge protection circuit 100 comprises a first voltage clamping circuit VDR1, G1 connected between the first power terminal 111 and the protective earth terminal 115. The first voltage clamping circuit comprises a voltage clamping component VDR1 and a conduction component G1.

The voltage clamping component VDR1 is configured to clamp a maximum voltage across the voltage clamping component to a (non-zero) clamping voltage.

One example of a suitable voltage clamping component is a varistor, e.g., a metal oxide varistor (MOV). When the voltage across a varistor exceeds a varistor threshold voltage, it breaks down and conducts electricity meanwhile clamping the voltage across it to a non-zero voltage, e.g., clamping the voltage across the varistor to the varistor threshold voltage.

Another example of a voltage clamping component is a Zener diode arranged such that a breakdown voltage of the Zener diode acts as the clamping voltage.

Other suitable examples will be apparent to the skilled person.

The conduction component G1 is any suitable component that becomes conductive (i.e., reduces its impedance to a low impedance) when a voltage across the conduction component exceeds a conduction component threshold voltage.

One example of a suitable conduction component is a gas discharge tube (GDT). When a voltage across the gas discharge tube exceeds a breakdown voltage for the GDT, it becomes conductive such that a voltage across the conduction component drops significantly, e.g. to zero or near zero (e.g., effectively negligible).

Another example of a suitable conduction component is a thyristor surge protective device (TSPD) or thyristor surge suppressor (TSS). The effective function of a TSPD/TSS is similar to that of a GDT, but reliant on a different mechanism.

Other suitable examples, e.g., those involving transistor-based arrangements, will be apparent to the skilled person.

In use, when a surge voltage occurs between the AC line and the protective earth, for example between the line L and the protective earth, this surge voltage is applied across the voltage clamping circuit VDR1, G1 (i.e., a common mode voltage at the power terminal 111). Usually, the parasitic impedance of an unconducive gas discharge tube is much higher than that of a MOV varistor, thus the surge voltage is most applied on the gas discharge tube and exceeds the conduction component threshold voltage of the conduction component G1. 10his component will quickly enter the low-voltage conduction state thereby turning on. Thus, the voltage across the conduction component will drop to a second clamping voltage.

Once the conduction component is turned on, the voltage across the conduction component rapidly drops. This increases the voltage across the voltage clamping component. This will cause the voltage clamping component to clamp the voltage across the voltage clamping component (and the overall voltage clamping circuit) to the clamping voltage.

In this way, the residual voltage provided to the load is determined by the clamping voltage (across the voltage clamping component) and the second clamping voltage across the conduction component, which is very low or negligible.

When the surge voltage has passed or ended, the voltage across the line and neutral is the normal AC sine-wave voltage. When the AC sine-wave voltage crosses zero at the first power terminal 111, the voltage across the voltage clamping circuit VDR1, G1 also drops to a very low potential such that the voltage clamping circuit can reset to high impedance by itself, and the conduction component Gl and the voltage clamping component VDR1 will automatically exit the low-voltage conduction state and increase its impedance.

It will be appreciated that an electronic parameter (e.g., voltage and/or current) across the voltage clamping circuit VDR1, G1 needs to fall to below a recovery threshold in order for the voltage clamping circuit to exit the low-voltage/low impedance conduction state and increase its impedance.

The surge protection circuit also comprises a second voltage clamping circuit VDR2, G1 between a second power terminal 112 and the protective earth terminal 115. If the surge occurs between the neutral N and the protective earth GND, the varistor VDR2 and the GDT G1 will trigger. The operation of the second voltage clamping circuit is similar/identical to that of the first voltage clamping circuit, and has not been described for the purposes of conciseness.

It has been herein recognized that such an existing surge protection device is designed for use with only an AC power supply. More particularly, the turning off of the voltage clamping circuit (i.e., the increasing of the impedance) relies upon the natural zero crossing of an AC signal provided by the AC power supply.

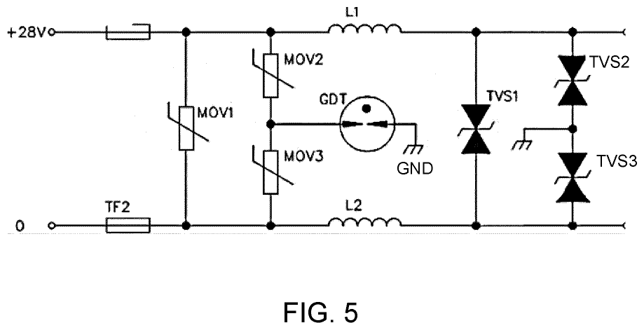

Putting the voltage clamping circuit on the DC side is known, as illustrated in FIG. 5. The normal DC voltage is 28V which may be sufficiently low to reset the voltage clamping circuit. However, the topology of such an existing surge protection device is not directly applicable if the AC power supply is replaced by a DC power supply in which there is no natural zero crossing of the DC signal provided by the DC power supply (as the DC signal is constant) and/or the DC voltage of DC signal is not low enough to reset the voltage clamping circuit (e.g., the DC power supply is a high-voltage DC power supply). More particularly, after the voltage clamping circuit is triggered (and even if the surge has ended) the power provided by the DC supply may provide an electrical parameter greater than the recovery threshold—i.e., such that the conduction component G1 will not exit the low-voltage conduction state. In this way, the voltage clamping circuit may continue to “freewheel” and conduct current. For example, in an LED driver, the normal output voltage of the DC is often several hundred Volts, and the corresponding potential between the DC positive and the protective earth is also a few hundred Volts and is therefore not able to reset the voltage clamping circuit.

The present disclosure proposes a technique for overcoming this problem.

More particularly, the present disclosure provides a technique for establishing an effective “near zero crossing point” of the DC signal to effectively interrupt the freewheeling of the voltage clamping circuit.

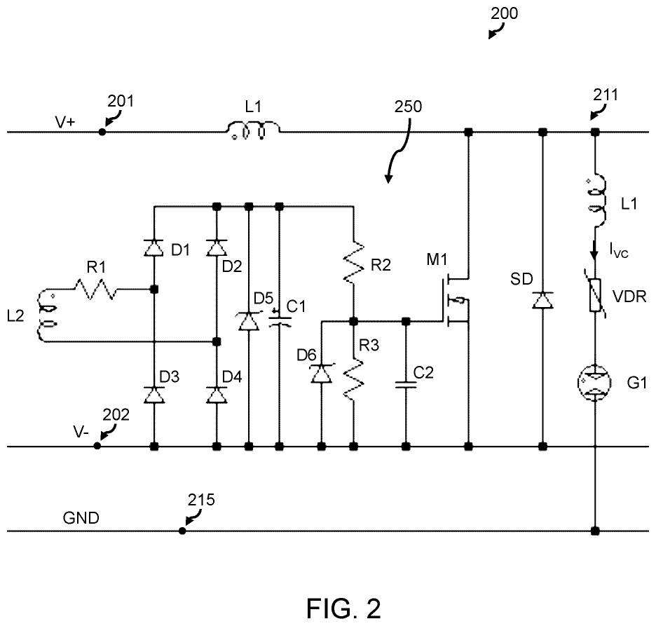

FIG. 2 illustrates a first embodiment of a surge protection circuit 200 for use between a DC power supply (not shown but potentially on the left hand of the circuit) and a load (not shown but potentially on the right hand of the circuit).

In the illustrated example, the DC power supply provides a first supply voltage V+ at a positive terminal 201 and a second supply voltage V− at a negative terminal 202. The first supply voltage is greater than the second supply voltage.

The surge protection circuit again comprises a power terminal 211 and a protective earth terminal 215. The power terminal 211 is configured to connect between the DC power supply and the load. The power terminal 211 may, for instance, be the positive terminal 201. The protective earth terminal is configured to connect to a protective earth GND.

The surge protection circuit 200 comprises a voltage clamping circuit VDR, G1 connected between the power terminal 211 and the protective earth terminal 215. The voltage clamping circuit VDR, G1 may be similar as those used for AC in FIG. 1.

The voltage clamping circuit VDR, G1 is configured to reduce its impedance to a low impedance and clamp the voltage across the voltage clamping circuit, responsive to a voltage across the voltage clamping circuit exceeding a surge threshold voltage—i.e., when a surge voltage occurs.

The voltage clamping circuit is also configured to recover to a high impedance responsive to an electrical parameter across the voltage clamping circuit falling below a recovery threshold. The electrical parameter may be a voltage across the voltage clamping circuit or a current through the voltage clamping circuit. Thus, the voltage clamping circuit may recover if the voltage across the voltage clamping circuit is below a second threshold voltage, lower than the surge threshold voltage, and/or if a current through the voltage clamping circuit is below a first threshold current.

Approaches for forming such a voltage clamping circuit have been previously described. In particular, the voltage clamping circuit may comprise a voltage clamping component VDR and/or a conduction component G1. If both components are present, these components are connected in series.

If present, the voltage clamping component VDR is configured to clamp a voltage across the voltage clamping component, optionally to a non-zero clamping voltage, when the across the voltage clamping circuit exceeds the surge threshold voltage (i.e., when a surge voltage occurs). This effectively reduces the impedance of the voltage clamping component for high voltage levels.

If present, the conduction component G1 is configured to become conductive responsive to the surge voltage across the voltage clamping circuit exceeding the surge threshold voltage. In particular, the conduction component may switch to have a low-impedance.

In this way, the impedance of the voltage clamping circuit is significantly reduced, causing current to flow through the voltage clamping circuit.

The surge protective circuit further comprises a control circuit 250 comprising an active switch M1. In the illustrated example, the active switch is a MOSFET, but can be replaced by any other form of switch or switching circuitry such as a BJT or even a Triac.

The active switch M1 is configured to when operated, limit the electrical parameter across the voltage clamping circuit below the recovery threshold. This effectively forces the voltage clamping circuit to reset to the higher impedance.

In the illustrated example, this is achieved by the active switch M1 (when operated) redirecting a current flow from the power terminal 211 to the negative terminal 202 (i.e., effectively short-circuiting the DC power supply or pulling down the potential of the positive power terminal). The active switch diverts the current from the voltage clamping circuit and thus the freewheel current in the voltage clamping circuit is interrupted, making the voltage clamping circuit reset.

In other examples, the active switch M1 is configured to (when operated) redirect a current flow from the power terminal 211 to the protective earth terminal 215. This effectively pulls down the potential of the positive power terminal towards the protective earth. The voltage across the voltage clamping circuit is therefore made substantially low and it resets.

The control circuit is adapted to operate the active switch, for at least a period of time, after the voltage exceeding the surge threshold voltage (e.g., the surge voltage) ends. Then it does not operate the active switch, and this will cause the voltage clamping circuit to recover to the high impedance, as the electrical parameter is reduced to or held at the recovery threshold.

In order to know the time when to operate the voltage clamping circuit and when not to, in the illustrated embodiments, the control circuit 250 further comprises a detecting component L1, L2 configured to sense a current through the voltage clamping circuit.

The control circuit is configured to operate the active switch M1 responsive to the sensed current. In particular, the control circuit 250 may operate or activate the active switch responsive to the sensed current rising above a second threshold current. This means that the active switch is operated when current flows through the voltage clamping circuit.

In the illustrated example, the detecting component comprises a first winding L1 connected in series with the voltage clamping circuit and a second winding L2 magnetically coupled to the first winding. Current flow through the first winding L1 induces a current flow in the second winding L2. The current flow through the second winding L2 charges a capacitor C1. When the voltage across the capacitor reaches a certain voltage, this indicates that the sensed current has risen to a second threshold current. The active switch M1 is then activated, e.g., by the capacitor C1 providing a suitable voltage to the gate of the active switch.

As illustrated in FIG. 2, the control circuit 250 may comprise additional control circuitry D1, D2, D3, D4, D5, D6, R1, R2, R3 for controlling the operation of the active switch. Nonetheless, the general principle of the control circuit remains the same.

For instance, the control circuitry may comprise a rectifying arrangement D1, D2, D3, D4 (e.g., in the form of a bridge rectifier) between the second winding L2 and the capacitor C1. This rectifier can detect surge across the V+ and GND of either positive or negative polarity. The capacitor C1 acts to convert the current through the second winding L2 to a voltage.

The control circuitry may comprise a resistor arrangement R1, R2, R3. One of more of the resistors of the resistor arrangement may be omitted. The resistor arrangement can act as a biasing arrangement for appropriate biasing of the gate voltage to the active switch by the capacitor C1.

The control circuit may also comprise a delay circuit capacitor C1/C2 configured to delay the sensed current through the voltage clamping circuit. The control circuit may be configured to operate, and optionally stop operating, the active switch responsive to the delayed sensed current.

More particularly, the control circuit 250 may operate the active switch responsive to the delayed sensed current rising above a first value; and stop operating the active switch responsive to the delayed sensed current falling below a second value. The first and second values may be the same, or may be different for hysteric control.

In the illustrated control circuit 250, this delay functionality is provided through use of the capacitor C1. In particular, if a current through the first winding L1 sudden rises (thereby increasing the current through the second winding L2), then the voltage across the capacitor will be still low for a period of time, and then operate the active switch M1, thereby effectively delaying the change to the active switch M1, this allow the voltage clamping circuit to kick in to bleed the surge. The delay can be set according to a normal lasting time of a surge, meaning that after the surge, the control circuit starts to operate the active switch M1.

Other approaches or techniques for performing such a delay will be apparent to the skilled person.

It will be appreciated that, in general, the DC power supply is configured to operate in an operation mode in which it generates a rated power at the power terminal. This rated power produces the electrical parameter(s) across the voltage clamping circuit higher than the recovery threshold. The DC power supply may provide this rated power when the terminals are not short-circuited, e.g., when the active switch is not active. The embodiment of FIG. 2 has another advantage due to that the active switch pulls the output terminal of the DC power supply. In many applications, the DC power supply is configured to, if the positive and negative terminals are short-circuited together, enter a protection mode in which the DC power supply reduces the power output at the positive terminal. In some embodiments, the active switch, when operated, short-circuits the DC power supply, to force it to enter a protection mode. In such protection mode, the output of the DC power supply is significantly reduced and the voltage on the positive output V+ may drop so low that it can reset the voltage clamping circuit. Thus, the DC power supply can be controlled to contribute to the suppression of the electrically parameter which freewheels the voltage clamping circuit and eventually stops the freewheel.

The protection mode of the DC power supply may also aim to provide a power that is lower than the recovery threshold. This can thereby allow the voltage clamping circuit to recover to a high impedance.

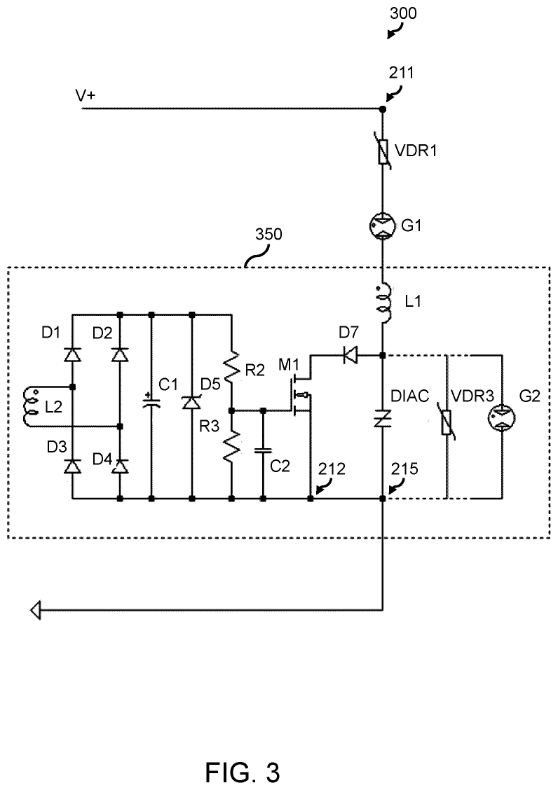

FIG. 3 illustrates an alternative surge protection circuit 300.

The overall structure of the alternative surge protection circuit 300 is similar to that of the previously described surge protection circuit 200. For the sake of conciseness, only the differences between the two circuits will be described. The difference of FIG. 3 is implementing the active switch in a different location.

The control circuit 350 further comprises a recoverable component DIAC, VDR3, GDT1 connected in series with the voltage clamping circuit. The recoverable component is one that is configured to become conductive and/or reduce its impedance once a breakdown voltage across said recoverable component has been exceeded. The recoverable component can then recover to a high impedance when an electrical parameter across/through the recoverable component (e.g., a voltage or current) falls below some recovery threshold.

Examples of recoverable components include a DIAC, a SiDAC, a varistor or a gas discharge tube. Other examples will be apparent to the skilled person. FIG. 3 illustrates three alternatives for the recoverable component. It will be appreciated that only a single recoverable component need be provided. This recoverable component has a smaller rating that than of the voltage clamping circuit, e.g., has a small rating of 20-40V compared to a 470V rating of the voltage clamping circuit.

The active switch M1 is positioned to be connected in parallel with the recoverable component. An optional diode is positioned such that current is able to flow to the active switch from the voltage clamping circuit VDR1, G1, but not vice versa.

The DC power supply again provides a supply voltage V+ at a power terminal 201. The surge protection circuit again comprises a protective earth terminal 215. The power terminal 211 is configured to connect between the DC power supply and the load. The power terminal 211 may, for instance, be the positive terminal 201. The protective earth terminal is configured to connect to a protective earth GND.

The surge protection circuit 200 comprises a voltage clamping circuit VDR1, G1 connected between the power terminal 211 and the protective earth terminal 215.

The voltage clamping circuit VDR1, G1 is configured to reduce its impedance to a low impedance and clamp the voltage across the voltage clamping circuit, responsive to a voltage across the voltage clamping circuit exceeding a surge threshold voltage—i.e., when a surge voltage occurs.

In use, when a surge voltage occurs at the power terminal 211, a voltage between the power terminal and the protective earth terminal is such that fires the voltage clamping circuit and the recoverable component and the impedance of the voltage clamping circuit and the recoverable component decreases. This permits a current to flow through the voltage clamping circuit, such that a current flows through the winding L1. This current flow is sensed by the second winding L2 and causes the active switch M1 to be operated (firstly switched on), with an optional time delay (e.g., caused by the charging of the capacitor C1). This creates an alternative current path for the current that bypasses the recoverable component, causing the recoverable component to turn off. When the voltage between the power terminal and the protective earth terminal decreases, then the active switch will be further operated to turn off (as the current flow through the first winding L1 reduces). This cuts off any path for the current through the voltage clamping circuit (as the recoverable component will not turn on due to an insufficient voltage and the active switch provides no current path). This therefore turns off the voltage clamping circuit.

In this way, the control circuit is configured to operate the active switch M1 to cause the voltage clamping circuit to recover to the high impedance by firstly closing the active switch M1 to bypass the recoverable component and recover the recoverable component to a high impedance state; and subsequently opening the active switch M1 to thereby cut off current through the voltage clamping circuit GDT.

Note that in this embodiment, in order to reset the voltage clamping circuit, the active switch is operated in a sequence of turning on and off. Whereas in the embodiment of FIG. 2, in order to reset the voltage clamping circuit, the active switch is operated just turn on. Depending on different implementation of the active switch, the way to operate the active switch to reset the voltage clamping circuit can also vary but all fall into the scope of “operate”.

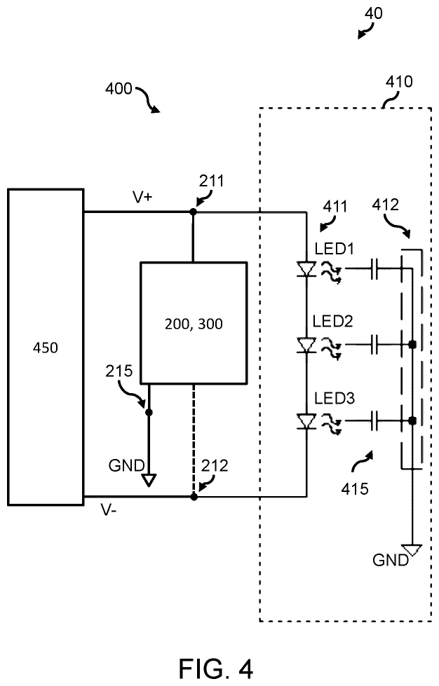

FIG. 4 illustrates a lighting arrangement 40 that employs embodiments of the invention. In particular, the lighting arrangement 40 comprises a lighting module 400 and a DC power supply 450.

The DC power supply 450 is configured to provide a first supply voltage V+ at a positive terminal 211 and a second supply voltage V− at a negative terminal 212. The first supply voltage is greater than the second supply voltage. There is also defined a protective earth GND.

The lighting module 400, which itself represents an embodiment, comprises any herein disclosed surge protection circuit 200, 300.

The lighting module 400 also comprises the load 410 (for the surge protection circuit), wherein the load comprises an LED lighting load 411. In particular, the LED lighting load may comprise one or more LEDs LED1, LED2, LED3. In the illustrated example, the LED lighting load comprises a string of LEDs.

The lighting module 400 also comprises a housing 412 for the LED lighting load, wherein the housing is by default configured to connect to the protective earth. This is schematically illustrated in FIG. 4.

Since the LED lighting load 411 is usually put on a conductive substrate placed close to the housing, the LED lighting load 411 and the housing 412 has a parasitic leakage path 415. Current is conducted along this parasitic leakage path when a voltage, e.g., a surge voltage, provided to the LED lighting load with respect to the protective earth exceeds a breakdown voltage. In case of break down, significant damage can be caused, for example the LED may be damaged by a huge break down current.

In order to prevent break down, preferably, the surge threshold voltage (at which the voltage clamping circuit effectively reduces its impedance) is less than this breakdown voltage. Thus the surge protection circuit would clamp the voltage over the lighting module effectively lower than the break down voltage, and this approach ensures that the voltage provided to the LED lighting load is prevented from reaching the breakdown voltage and the lighting load never breaks down.

The surge protection circuit is coupled between one of the positive and negative terminals (acting as a power terminal) and either: the other of the positive and negative terminals or the protective earth terminal 215.

The DC power supply 450 may be configured to be operable in an operation mode, in which it provides a rated power at the power terminal 211. This rated power may be able produce the electrical parameter across the voltage clamping circuit higher than the recovery threshold, e.g., have a sufficiently high voltage and/or current that is greater than the recovery threshold. This approach makes the advantage of the proposed active switch clear.

Example configurations for DC power supplies are well known to the skilled person, and may include one or more cells or batteries and/or an AC-DC converter. DC power supplies may include further circuitry, e.g., for performing power factor correction, DC-DC conversion (e.g., voltage regulators) or the like. The precise configuration or design of the DC power supply is immaterial to the underlying inventive concept, but certain design characteristics can be exploited to advantage.

For instance, some DC power supplies may be configurable to enter a protection mode upon its outputs being short circuited. In a protection mode, the DC power supply is configured to reduce the power on the positive output to a lower power (“protection power”) than the rated power. This configuration can be exploited by a control circuit may configured to control circuit to short-circuit the DC power supply (e.g., only) when the active switch is operated or activated, such as the embodiment shown in FIG. 2. The voltage clamping circuit may be designed such that the protection power is lower than the recovery threshold. This causes the voltage clamping circuit to recover to the high impedance. This technique thereby makes use of the operation of the DC power supply to control the recovery of the voltage clamping circuit.

No matter whether the DC power supply has such protection mode, the embodiment shown in FIG. 3 can also be used to actively cut off the voltage clamping circuit from any power and reset the voltage clamping circuit.

FIG. 4 illustrates a lighting arrangement that makes use of a proposed surge protection circuit. The lighting arrangement comprises the LED lighting module as described above, and the DC power supply 450, with a positive output of the DC power supply connected to the positive input of the load via the positive terminal of the surge protection circuit and a negative output of the DC power supply connected to the negative input of the load via the negative terminal of the surge protection circuit, wherein the DC power supply is configured to operate in an operation mode after the voltage exceeding the surge threshold voltage ends in case that the active switch is not operated, in which operation mode the DC power supply is adapted to generate a rated power at the power terminal which rated power is able produce the electrical parameter across the voltage clamping component higher than the recovery threshold.

The DC power supply is configured to provide a first supply voltage at a positive terminal and a second supply voltage at a negative terminal, the first supply voltage being greater than the second supply voltage; and the control circuit is configured to short circuit the DC power supply, wherein said DC power supply is adapted to, upon the short circuiting, switch from the operation mode to a protection mode and reduce the power on the positive output to a lower power than the rated power, wherein the lower power is adapted to generate the electrical parameter across the voltage clamping component lower than the recovery threshold so as to recover the voltage clamping component to high impedance.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A surge protection circuit for use between a DC power supply and a load, the surge protection circuit comprising:
a positive power terminal, of the surge protection circuit, configured to connect between a positive output of the DC power supply and a positive input of the load, and
a negative power terminal, of the surge protection circuit, configured to connect between a negative output of the DC power supply and a negative input of the load;
a protective earth terminal configured to connect to a protective earth;
a voltage clamping circuit connected between the one of the positive and negative power terminals and the protective earth terminal and adapted to:
reduce its impedance to a low impedance and clamp the voltage across the voltage clamping circuit, responsive to a surge voltage between the one of the positive and negative power terminals and the protective earth terminal across the voltage clamping circuit exceeding a surge threshold voltage; and
recover to a high impedance responsive to an electrical parameter across the voltage clamping circuit falling below a recovery threshold; and
a control circuit, comprising
a detecting component configured to sense a current through the voltage clamping circuit to the protective earth; and
an active switch connected between the positive power terminal;
wherein the control circuit is adapted to operate the active switch, responsive to the sensed current, to short circuit the DC power supply after the surge voltage ends, to limit the electrical parameter across the voltage clamping circuit below the recovery threshold to thereby cause the voltage clamping circuit to recover to the high impedance,
a recoverable component connected in series with the voltage clamping circuit; and
an active switch is connected in parallel with said recoverable component, wherein recoverable component has a smaller voltage rating than that of the voltage clamping circuit and the control circuit is configured to operate the active switch to cause the voltage clamping circuit to recover to the high impedance by closing the active switch to bypass the recoverable component and recover the recoverable component to a high impedance state; and subsequently opening the active switch to thereby cut off current through the voltage clamping circuit.

2. The surge protection circuit of claim 1, wherein the electrical parameter across the voltage clamping circuit falls below a recovery threshold when any one or both of:
the voltage across the voltage clamping circuit as the electrical parameter is below a second threshold voltage, lower than the surge threshold voltage, and
a current through the voltage clamping circuit as the electrical parameter is below a first threshold current.

3. The surge protection circuit of claim 1, wherein the voltage clamping circuit comprises at least one of:
a voltage clamping component configured to clamp a voltage across the voltage clamping component, optionally to a non-zero clamping voltage, responsive to the voltage across the voltage clamping circuit exceeding the surge threshold voltage; and
a conduction component configured to become conductive responsive to the voltage across the voltage clamping circuit exceeding the surge threshold voltage.

4. The surge protection circuit of claim 1, wherein:
the control circuit is configured to operate the active switch responsive to the sensed current, rising above a second threshold current.

5. The surge protection circuit of claim 4, wherein the control circuit is configured to stop operating the active switch responsive to the sensed current falling below the second threshold current, optionally falling to zero.

6. The surge protection circuit of claim 4, wherein:
the control circuit further comprises a delay circuit configured to delay the sensed current through the voltage clamping circuit; and
the control circuit is configured to operate, and optionally stop operating, the active switch responsive to the delayed sensed current.

7. The surge protection circuit of claim 6, wherein the control circuit is configured to:
operate the active switch responsive to the delayed sensed current rising above a first value; and
stop operating the active switch responsive to the delayed sensed current falling below a second value.

8. The surge protection circuit of claim 4, wherein the detecting component comprises:
a first winding connected in series with the voltage clamping circuit; and
a second winding magnetically coupled to the first winding so as to produce a current responsive to a current flow through the voltage clamping circuit,
wherein the control circuit is adapted to operate the active switch responsive to the produced current.

9. The surge protection circuit of claim 1, wherein the voltage clamping circuit connected between the positive power terminal and the protective earth terminal.

10. The surge protection circuit of claim 9, wherein the voltage clamping circuit connected between the negative power terminal and the protective earth terminal.

11. A lighting module comprising:
the surge protection circuit of claim 1;
the load, wherein the load comprises an LED lighting load; and
a housing for the LED lighting load, wherein the housing is configured to connect to the protective earth,
wherein the LED lighting load and the housing has a parasitic leakage path along which the LED lighting load is breaking down when a voltage, optionally a surge voltage, provided to the LED lighting load with respect to the protective earth exceeds a breakdown voltage.

12. The lighting module of claim 11, wherein the surge threshold voltage is lower than the breakdown voltage, thereby causing the surge protection circuit to be adapted to prevent the voltage provided to the LED lighting load reaching the breakdown voltage.

13. A lighting arrangement comprising:
the lighting module of claim 11; and
the DC power supply, with a positive output of the DC power supply connected to the positive input of the load via the positive terminal of the surge protection circuit and a negative output of the DC power supply connected to the negative input of the load via the negative terminal of the surge protection circuit,
wherein the DC power supply is configured to operate in an operation mode after the voltage exceeding the surge threshold voltage ends in case that the active switch is not operated, in which operation mode the DC power supply is adapted to generate a rated power at the positive and negative power terminals which rated power is able produce the electrical parameter across the voltage clamping component higher than the recovery threshold.

14. The lighting arrangement of claim 13, wherein:
the DC power supply is configured to provide a first supply voltage at a positive terminal and a second supply voltage at a negative terminal, the first supply voltage being greater than the second supply voltage; and
the control circuit is configured to short circuit the DC power supply, wherein said DC power supply is adapted to, upon the short circuiting, switch from the operation mode to a protection mode and reduce the power on the positive output to a lower power than the rated power, wherein the lower power is adapted to generate the electrical parameter across the voltage clamping component lower than the recovery threshold so as to recover the voltage clamping component to high impedance.
